(19) United States
(12) Patent Application Publication
(10) Pub. No.: US 2015/0175416 A1
(43) Pub. Date: Jun. 25, 2015

(54) FEED RATIO CONTROL FOR HTER

(71) Applicant: Haldor Topsoe A/S, Kgs. Lyngby (DK)

(72) Inventors: Martin F. Jensen, Vallensbæk Strand (DK); Claus F. Hansen, Hørsholm (DK); Søren G. Thomsen, Lyngby (DK)

(21) Appl. No.: 14/636,989

(22) Filed: Mar. 3, 2015

Related U.S. Application Data
(63) Continuation-in-part of application No. 14/151,435, filed on Jan. 9, 2014.

(30) Foreign Application Priority Data
Jan. 14, 2013 (DK) PA 2013 00025

(51) Int. Cl. C01B 3/34; B01J 19/02

(52) U.S. Cl. CPC C01B 3/34; B01J 19/02; B01J 2219/0277; C01B 2203/0205; C01B 2203/0844; C01B 2203/142

(57) ABSTRACT

The invention provides a Heat Exchange Reformer (HER) arranged to be part of a synthesis gas production unit and comprising at least a first and a second metal in order to minimise metal dusting. The invention moreover relates to a method for improved thermal control in a Heat Exchange Reformer (HER) and a computer readable storage medium. The invention provides improved thermal control and reduced metal dusting of the Heat Exchange Reformer.

This is a continuation-in-part of application Ser. No. 14/151,435, filed Jan. 9, 2014, now abandoned, the entire disclosure of which is herein incorporated by refer-ence.

### BACKGROUND OF THE INVENTION

In connection with synthesis gas production by steam reforming, high temperatures are required in order to achieve a feasible conversion of the hydrocarbons into synthesis gas.

In the traditional synthesis gas plants, the sensible heat in the synthesis gas has been used for steam generation. Doing a pinch point analysis on this will typically lead to the conclusion that the sensible heat in the gas from the reformer can be utilised better, as the temperature differ-ence in the hot end typically is in the range from 650-750° C. However, due to the corrosion phenomenon known as metal dusting, it is a challenge to design the heat exchange apparatus in such a way that plant reliability is not jeopardised. Even in the waste heat boilers used in traditional synthesis gas plants where the possibility of hot metal surfaces with affinity for metal dusting is significantly reduced due to relatively low temperature and high heat transfer coefficients on the steam/water side, failures due to metal dusting have been seen.

When designing an apparatus utilising the sensible heat from the steam reforming section, it is thus of utmost importance that a significant knowledge and experience of the metal dusting phenomenon is available.

Typically, pinch point analysis and/or CAPEX/OPEX (Capital Expenses/Operational Expenses) evaluations show that the temperature approach shall be between 10-150° C. to have the optimum balance between investment and operating cost. The higher value is normally relevant for more “exotic” materials, i.e. in environments with high temperature and/or high corrosion potential.

For the synthesis gas generation, the temperature outlet the main reforming section is in the range from 850-1050° C. which means that the sensible heat could be used for heating a process stream to 600-900° C. Such a stream does not exist in the synthesis gas process apart from the reforming process itself. Thus, different concepts have been considered for utilisation of the sensible heat in the synthesis gas from the main reformer for further steam reforming, e.g. Aasberg-Petersen K., Dybkjær I., Ovesen C. V., Schjødt N. C., Sehested J., Thomsen S. G. “Natural gas to synthesis gas—Catalysts and catalytic processes”, Journal of Natural Gas Science and Engineering, 2011.

The gas heated steam reformer may be located either in series with the main reformer (referred to as HTER-s, i.e. heat exchange reformer in series) or in parallel (HTER-p) with the main reformer. The main reformer can either be a tubular reformer, a secondary reformer or an autothermal reformer. The HTER-s has the advantage that a higher aver-age outlet temperature can be obtained which is advanta-geous with respect to the overall conversion of feed and also—in particular for synthesis gas for synthetic fuel—a higher CO/H₂ ratio, whereas the overall pressure drop in the front-end is lower for the HTER-p concept. In the following only the HTER-p will be discussed, and in FIGS. 1-3 the implementation of the HTER-p in different plant types is shown.

The typical operating parameters from the main reformer are shown in Table 1.

TABLE 1
Typical conditions for main reformer

| | | | ATR- |
|---|---|---|---|
| | H₂ | NH₃ | based |
| | plant | Plant | plant |
| Steam-to-carbon | 1.8-2.5 | 2.5-3.6 | 0.6-0.9 |
| ratio | | | |
| Secondary reformer | No | Yes | — |
| Outlet temperature | 850-930 | 950-1000 | 1000-1050 |
| (main reformer), | | | |
| ° C. | | | |
| H₂/CO ratio | 3.3-4.5 | ~4 | ~2 |

The duty of the HTER-p can typically be up to 40-50% of the duty of the Waste Heat Boiler (and steam superheater, if applicable) applied in a standard plant configuration, and the reforming capacity corresponds to 25-30% of the capacity of the main reformer. In ammonia, methanol and hydrogen plants, this means that the duty of the tubular/primary reformer can be reduced correspondingly. Apart from the reduction in the reformer size, also the fuel consumption and waste heat to be recovered are significantly reduced, resulting in lower overall feed+fuel consumption and a reduced size of the waste heat section of the tubular reformer. For plants where the autothermal reformer (ATR) is applied, the oxygen requirement for the ATR is reduced, con-sequently resulting in lower operating cost for the air separation unit and a reduced unit size. As economy of scale is in particular relevant for synthetic fuel plants, and the air separation unit capacity often is the bottle-neck, the implementation of the HTER-p (and HTER-s) can boost the total plant capacity for the same O₂ consumption.

As described above the efficiency with respect to feed and fuel consumption of the synthesis gas plant is improved, and the CO₂ emission is reduced. In some cases, however, the steam generated in the synthesis gas plant may have a significant value in the entire complex, and for such cases it is important to valorise the steam export from the synthesis gas plant; see Andersen N. U., Olsson H., “The hydrogen generation game”, Hydrocarbon Engineering 2011. Often the steam generation efficiency in the synthesis gas plant can be as high as 94%, whereas the typical efficiency of an auxiliary boiler is 92.5% However, as the efficiency of the auxiliary boilers improve (for instance by implementation of power generation from low temperature calories by use of Organic Rankine Cycle) and major pump and compressor drives change to electricity, the advantage of the HTER becomes more and more significant.

In the HTER-p high heat transfer coefficients are obtained when comparing to the overall heat transfer obtained in fired tubular reformers and this results in a very small plot area for the HTER-p compared with the tubular reformer (see Table 2).

TABLE 2
Reactor volume and Transferred duty in reformers
(Essar Oil H₂ plant as example)

| | | Tubular |
|---|---|---|
| | HTER-p | reformer |
| Transferred Duty, | 23 | 96 |
| Gcal/h | | |
| Reactor/furnace volume, | 48 | 2900 |
| m³ | | |
| “Heat intensity”, | 480,000 | 33,000 |
| kcal/h per m³ | | |

It is seen that the heat intensity for the HTER-p is more than a factor 10 higher than the intensity for a typical tubular reformer, which supports the fact that a HTER-p is a feasible way of adding reforming capacity to a new or existing tubular reformer, despite the fact that the con-struction of the HTER-p is more complicated, and the con-struction materials are more expensive.

In order to minimise the overall cost for the entire plant, it is important to know the crucial parameters in the entire plant. Topsøe has two types of HTER-p in commercial operation: 1) The bayonet tube HTER-p, and 2) the double tube HTER-p.

The bayonet tube HTER-p (see FIG. 4) consists of a tube bundle where each tube assembly consists of three concen-tric tubes. In the outer annulus flow, the heating gas from the main reformer flows upwards, in the middle annulus the feed gas flows downwards through a catalyst bed, wherefrom it exits and turns into the central tube (the bayonet tube) and flows upwards to the outlet chamber, where the cooled reformed gas is mixed with the cooled heating gas from the outer annulus.

The double tube HTER-p (see FIG. 5) consists of a tube bundle with double tubes. Catalyst is loaded inside the centre tubes and outside the outer tubes. The feed gas flows downwards through the catalyst inside tube and through the catalyst outside tube. The reformed gas from the catalyst beds is mixed with the heating gas from the main reformer and flows upwards in the annulus between the double tube assembly, while heat exchanging with the gas flowing in the catalyst beds.

Typically, for plants where a high conversion is very important, the temperature outlet the catalyst bed shall be as high as possible in order to ensure a minimum methane leakage in the synthesis gas. This is for instance often the situation in ammonia plants and in hydrogen plants with a tight fuel balance when operating at low steam-to-carbon ratio. In such a case the bayonet type HTER-p is optimum, as the heating gas from the main reformer (tubular reformer or secondary reformer) is not mixed with the HTER-p catalyst effluent gas before heat exchange has taken place. This results in a higher reforming temperature (approximately 30-40° C.) in the HTER-p for the same temperature approach in the hot end of the HTER-p than for the double tube HTER-p. In cases, where the methane slippage is less significant, the double tube HTER-p has the advantage of being more compact, as the space between the tube assem-blies is utilised as catalyst bed and makes the HTER-p even more compact. The double tube HTER-p is typically the most feasible solution in ATR-based plants where the main reformer outlet temperature is relatively high and in hydrogen plants, where the fuel balance allows for this design (often in plants where the steam-to-carbon ratio is dictated by the type of feedstock).

The above criteria are typically only, and many other fac-tors may influence the final and the most feasible layout of the HTER-p.

A major challenge in connection with Heat Exchange Reformers heated by reformed process gas is corrosion by metal dusting, which typically can occur in the temperature range from 400-800° C. in atmospheres rich in CO and/or hydrocarbons.

The precursor for metal dusting is the carbon formation and the possible mechanisms for carbon formation in a reformed gas are, see Agaero A., Gutierrez M., Korcakova L., Nguyen T. T. M, Hinnemann B., Saadi S. “Metal Dusting Protective Coatings. A Literature Review”, Oxidation of Metals, 2011:

### Boudouard Reaction

2CO [symbol] C+CO₂ (1)

### CO Reduction

CO+H₂ [symbol] C+H₂O (2)

### Methane Decomposition

CH₄ [symbol] C+2H₂ (3)

The Boudouard reaction (1) and the CO reduction reaction (2) are both exothermic reactions, i.e. when the actual temperature is below the equilibrium temperature there are affinity for carbon formation from the two reactions. However, at a certain temperature, say 400-450° C., the reaction rate is so low that insignificant corrosion takes place in practise. The methane decomposition reaction (3) is endo-thermic, i.e. affinity for carbon formation exists above the equilibrium temperature. In Table 3 typical equilibrium temperatures are shown for the carbon forming reaction.

TABLE 3
Typical equilibrium temperatures for carbon-
forming reactions in different plant types

| | | | ATR- |
|---|---|---|---|
| | H₂ | NH₃ | based |
| Equilibrium temperature | plant | plant | plant |
| Boudouard reaction, | 790-800 | 800-810 | |
| T_{eq,} ° C. | | | |
| CO reduction, T_{eq}, | 750-780 | 760-770 | |
| ° C. | | | |
| Methane decomposition, | >950 | >1200 | |
| T_{eq}, ° C. | | | |

It is seen that the process gas passes through the critical temperature range, and affinity for carbon formation and potential for metal dusting exist. Having affinity for carbon is not necessarily the same as having unacceptable metal dusting corrosion (but often it is). Some commercial alloys have long incubation times and low corrosion rates, making them suitable for operation under conditions with affinity for metal dusting. However, operation under conditions with affinity for carbon formation requires extensive testing prior to use in commercial units, and Topsøe is continuously testing materials and operating conditions in order to map metal dusting attacks in the laboratory and has an extensive collaboration with leading companies de-veloping special alloys. Finally, but not least, Topsøe does have successfully industrial experience for more than a decade in operation of convective reformers within the metal dusting area.

Haldor Topsese A/S (Topsøe) has had convective reformers in operation since 1990. The first heat exchanger reformers were based on convection from flue gases (Haldor Topsøe Convective Reformers, “HTCR”). Most of the HTCRs in operation (more than 30) are of the bayonet type (see FIG. 6) and do have relatively complex heat transfer mechanisms. An extensive feedback and experience of the heat transfer in convective reformers have been obtained from these units and have been used to optimise the design of the other types of convective reformers.

In 2003, the first HTER was successfully started in South Africa in Sasol's Synfuel Plant in Secunda, and it has been in operation since then (Thomsen S. G., Han P. A., Loock S., Ernst W. “The first Industrial Experience with the Haldor Topsøe Exchanger Reformer, AIChE Ammonia Safety Symposium, 2006). The HTER is of the Double-Tube type and by applying the HTER, the synthesis gas production was boosted by more than 30%. The operating conditions for this reformer are relatively severe with respect to metal dusting due to the high temperature and low steam-to-carbon ratio. The first tube bundle was in operation for more than seven years and the metal dusting corrosion was within the expected rate and not the reason for replacement of the tube bundle.

In 2010, a Bayonet type HTER was started in India at Numa-ligarh Refinery Limited (Konwar S., Thakuria A. “New Para-digms in Revamp Options for Hydrogen Units—The HTERp in NRL” 16th Refinery Technology Meet., 2011). The HTER was part of a revamp related to an overall H₂ demand in the refinery complex due to more strict environmental requirements to the fuel products. The original capacity of the existing Hydrogen Unit was 38000 MTPY (52,400 Ne/h) and the additional H₂ production provided by the HTER is 14,600 Nm³/h, i.e. a capacity increase of more than 25%.

In 2007, Essar Oil Vadinar Limited and Haldor Topsøe en-tered into an agreement for design of a hydrogen unit with a capacity of 130,000 Nm³/h hydrogen.

Considering the operating cost and the advantages with respect to feed and fuel consumption for the hydrogen unit, Essar Oil decided to implement a double tube HTER. The configuration of the hydrogen unit is shown in FIG. 7. The plant is designed for high flexibility and both natural gas, refinery fuel gas, LPG and naphtha as feedstock. In order to accommodate the high flexibility in the feed-stocks, a steam-to-carbon ratio of 2.5 has been selected for the prereformer and tubular reformer ensuring that the prereformer operation is optimised.

The tubular reformer has been designed with a maximum operating outlet temperature of 915° C. in order to achieve the highest efficiency and conversion, and furthermore it allows for even better utilisation of the HTER-p. The duty of the HTER-p is approximately 23 Gcal/h corresponding to approximately 40% of the sensible heat in the synthesis gas when cooling it to approximately 280° C. (the normal outlet temperature from the Waste Heat Boiler). The duty also corresponds to a reduction of the feed and fuel to the hydrogen unit of approximately 5% (and the steam export is reduced accordingly).

As mentioned above, it is very important to ensure that the temperature of the metal surfaces is within certain limits to avoid excessive corrosion caused by metal dusting. For the HTER-p in the Essar Oil H₂ plant, the most important parameter is the CO reduction temperature. As the synthesis gas passes through the critical temperature with affinity for metal dusting while transferring heat to the catalyst beds, it is important that materials with sufficient resistance towards metal dusting are selected for the relevant parts of the tube bundle. The selection of the materials is optimised considering both cost and operational flexibility. As the Essar Oil H₂ plant is designed with a prereformer and the feed to the HTER-p is taken downstream the prereformer, the feed composition (at a constant steam to carbon ratio) to the HTER-p is relatively constant, ir-respectively of the variation in feedstock type (NG, RFG, LPG, or naphtha) but other parameters are important for the temperature profile in the HTER:
Relative feed ratio to HTER compared to tubular reformer
Tubular reformer outlet temperature
Steam-to-Carbon ratio

In FIG. 8, the impact of the above parameters on the temperature profile is shown.

The selection of materials is done in order to ensure a robust design allowing variations in the plant operating parameters, and in order to facilitate the control and minimise the corrosion caused by metal dusting, the plant is designed with algorithms ensuring that the feed flow to the HTER is controlled in an optimum way.

As seen from FIG. 8, significant parameters for the temperature profile are the HTER feed flow rate and the tubular reformer outlet temperature. As the tubular reformer outlet temperature may be dictated by other requirements (reformer tube metal temperature, tubular firing rate etc.), it has been selected to manipulate the feed flow rate to the feed flow to the HTER in order to have the optimum temperature profile in the HTER:

F_{HTER}=f(F_{tub.ref},T_{out,tub.ref},S/C)

where
F_{HTER}: Feed flow rate to HTER
F_{tub.ref}: Feed flow rate to tubular reformer
T_{out,tub.ref}: Outlet temperature from tubular reformer
S/C: Steam-to-Carbon ratio to reforming section

By Steam-to-Carbon (S/C) is mean the molar ratio of H₂O to carbon in a given process stream.

The equilibrium temperatures for the carbon-forming reactions are affected by the outlet temperature from the tubular reformer and the steam-to-carbon ratio. The equilibrium temperatures are reduced for decreased outlet temperature and increased stem-to-carbon ratio, so operating conditions considered milder for the tubular reformer are also milder for the HTER and thus giving a kind of self-regulation, as long as the ratio of feed to HTER and the tubular reformer is kept constant. However, it is recommended always to uti-lise the advanced algorithms as it will facilitate the control and minimise the risk of premature failure due to mal-operation.

The HTER-p has been designed and procured by Topsøe. The pressure shell is refractory-lined, and the refractory was dried out at site in August 2011 prior to the commissioning of the plant. The pressure shell refractory cannot be dried out during the precommissioning/commissioning (as the refractory in the outlet collector) as no flow is intended to pass along the refractory during commissioning (or operation).

In September 2011, the pressure shell was erected and the tube bundle was installed.

The HTER-p was loaded with Topsøe catalyst for heat exchange reformers in the size 16×8 mm in November 2011, and it went smoothly and with very low deviation between the loading densities and pressure drops (+3.1/−2.2%) in the tubes was obtained. This ensures a good flow distribution between the tubes. The total catalyst loading time for both the catalyst inside the tubes and the catalyst outside the tubes was ten days on day shifts. It is expected that this time can be reduced and comparing with a conventional tubular reformer with a similar H₂ production capacity (32,000 Nm³/h, corresponding to 80-100 reformer tubes), the loading time for the HTER was only 3-4 days longer, which can be considered reasonable taking the compactness of the HTER into consideration and the fact that loading of HTER typically not is on the critical path.

The H₂ plant was mechanically completed and fully precommissioned in January 2012 and commissioning was started immediately after. The heating-up of the reforming section (prereformer, tubular reformer and HTER-p) in circulating nitrogen was started on 12 January, and on 15 January feed was introduced to the reforming section.

The Essar Oil H₂ plant is designed with a Medium Temperature Shift (MTS), and due to the availability of import hydrogen for start-up, it was chosen to reduce the MTS catalyst by H₂ produced by the H₂ plant itself with the Medium Temperature Shift by-passed. This can be done by operating the reforming section at reduced capacity, reduced outlet temperatures from the reformers (tubular reformer and HTER), and increased steam-to-carbon ratio, in this way producing a synthesis gas suitable for feeding into the Pressure Swing Adsorption (PSA) unit and in this way producing H₂ for the MTS catalyst reduction.

The MTS catalyst reduction was finalised on 20 January, and the Medium Temperature Converter was inserted on the same day, and on 21 Jan. 2012 a capacity of 60% was reached, and on 22 Jan. 2012 85% production capacity was reached. H₂ plant was run as per H₂ demand in the refinery complex.

The H₂ plant was restarted early in the second quarter of 2012, and in May 2012 a demonstration run at 100% capacity was performed. The operating data has been analysed using a data reconciliation programme ensuring that the analysis of the plant and the HTER is done on basis of a consistent data set without errors on the heat and mass balances. The operation and consumption figures were as expected at a production capacity of 130,130 Nm³/h, and it was shown by an on-site optimisation that consumption figures better than expected and guaranteed could be obtained (see Table 4).

TABLE 4
Specific Net Energy Consumption (Gcal/1000 Nm³ H₂)
(the columns “fuel opt.” indicates 4 hours optimised
period of demonstration run)

| | | Raw data | | Reconciled data | |
|---|---|---|---|---|---|
| | Design | Dem. run | (fuel opt.) | Dem. run | (fuel opt.) |
| Feed + Fuel − | 3.15 | 3.15 | 3.12 | 3.17 | 3.14 |
| Steam | | | | | |
| Feed + Fuel | 3.39 | 3.42 | 3.39 | 3.45 | 3.42 |
| Feed | 3.16 | 3.04 | 3.04 | 3.06 | 3.06 |

The operation and performance of the HTER-p during the demonstration run has also been evaluated, and the temperatures measured fit well with the temperatures simulated by the Topsøe reformer model (see FIG. 9), and indicates that the actual heat transfer at start-of-run is slightly better than the heat transfer predicted by the model.

An evaluation of the temperature profile comparing the di-rect output from the reformer model with a simulation using the reconciled terminal temperatures indicates that the location of the critical temperature is shifting only approximately 0.5 m, and for this case (and in general for the double tube HTER-p) the location is moving upwards, i.e. further into the part of the tube assembly consisting of materials with high resistance towards metal dusting. See e.g. FIG. 10

In conclusion, installation of a Haldor Topsøe Exchange Reformer can significantly reduce the feed and fuel consumption for an H₂ plant and thus also the CO₂ emission from the plant. The HTER-p is a very compact reformer, having very high heat intensity, making it feasible for both grass-root plants and revamp projects.

It is important that design tools for sizing the reformer predict both the heat transfer and the catalyst activity precisely and take into account the interaction between thermal design and catalyst performance. Over-estimating the heat transfer and catalyst activity will result in an apparatus which cannot meet the design capacity, but applying a “design margin” is not the solution as too good heat transfer and/or catalyst activity may result in critical operation with metal dusting attacks.

The commissioning and operation of the Essar Oil H₂ plant shows that the implementation of the HTER-p does not affect the commissioning and start-up time adversely, and the operation of the HTER-p is robust and safe and does not affect the plant reliability. Evaluation of the operating data from Essar Oil H₂ plant shows that the models used for predicting the heat transfer and catalyst are very accurate and ensure a proper and safe design of the HTER-p.

U.S. Pat. No. 6,224,789 describes a process for producing synthesis gas comprising an autothermal reformer and a heat exchange reformer in parallel in which the effluent from the autothermal reformer is used to heat the heat exchange reformer.

### BRIEF DESCRIPTION OF THE DRAWINGS

FIGS. 1-3 show the implementation of an HTER-p in different plant types.

FIG. 4 shows a bayonet tube HTER-p.

FIG. 5 shows a double tube HTER-p.

FIG. 6 shows a bayonet type HTCR.

FIG. 7 shows the configuration of a hydrogen unit of a double tube HTER.

FIG. 8 shows the impact of certain parameters on the temperature profile of a HTER.

FIG. 9 shows an evaluation of the HTER-p terminal temperature.

FIG. 10 shows the simulated and actual temperature of the HTER-p.

### DETAILED DESCRIPTION OF THE INVENTION

By the present invention, a method is disclosed in which a metal resistant to metal dusting is used at a distance from the inlet of the heat exchange reformer, and in which such distance is calculated from the steam to carbon ratio, effluent outlet temperature and hydrocarbon flow of the main reformer, as well as the steam to carbon ratio and hydrocarbon flow rate of the heat exchange reformer.

The present invention relates to a Heat Exchange Reformer (HER) arranged to be part of a synthesis gas production unit, said synthesis gas production unit comprising a Main Reforming Unit (MRU) and said Heat Exchange Reformer (HER). In operation, the effluent from the MRU is arranged so as to provide heat to the HER, and wherein a hydrocarbon feedstock is arranged so as to pass in parallel through both the MRU and the HER. The invention thus provides:
a. an MRU hydrocarbon feed having an MRU steam-to-carbon ratio (MRU_{S/C}), an effluent outlet temperature (T_{MRU}) and a MRU hydrocarbon flow rate (F_{MRU}) and
b. an HER hydrocarbon feed having an HER steam-to-carbon ratio (HER_{S/C}) and an HER hydrocarbon flow rate (F_{HER}),
wherein said Heat Exchange Reformer comprises a first metal and a second metal, in that:
   at a distance greater than a distance (A) from the inlet of the HER, the HER is of a first metal having a higher resistance to metal dusting; and
at a distance less than said distance (A) from the inlet of the HER, the HER is of a second metal which has a lower resistance to metal dusting than said first metal.

The distance A is determined from the temperature profile within the HER varying with the distance from the inlet of the HER as a function of the ratio of F_{HER}/F_{MRU}, the MRU outlet temperature (T_{MRU}), the MRU steam-to-carbon ratio (MRU_{S/C}), the HER steam-to-carbon ratio (HER_{S/C}) and the total hydrocarbon flow rate (F_{MRU}+F_{HER}); and wherein the distance (A) is as a distance (A) at which metal dusting is not significant.

The present invention further relates to a method for improved thermal control in a Heat Exchange Reformer (HER) of a synthesis gas production unit, where the synthesis gas production unit comprising a Main Reforming Unit (MRU) and a Heat Exchange Reformer (HER. The effluent from the MRU is arranged so as to provide heat to the HER, and a hydrocarbon feedstock is arranged so as to pass in parallel through both the MRU and the HER, thus providing:
a. an MRU hydrocarbon feed having a MRU steam-to-carbon ratio (MRU_{S/C}), an effluent outlet temperature (T_{MRU}) and a MRU hydrocarbon flow rate (F_{MRU}) and
b. an HER hydrocarbon feed having an HER hydrocarbon flow rate (F_{HER}),

The method comprises: adjusting the ratio of F_{HER}/F_{MRU} by adjusting the hydrocarbon flows to the MRU and HER on the basis of the MRU_{S/C}, the T_{MRU}, the HER_{S/C}, and the total hydrocarbon flow (F_{MRU}+F_{HER}), so as to maintain a stable temperature profile in the Heat Exchange Reformer (HER).

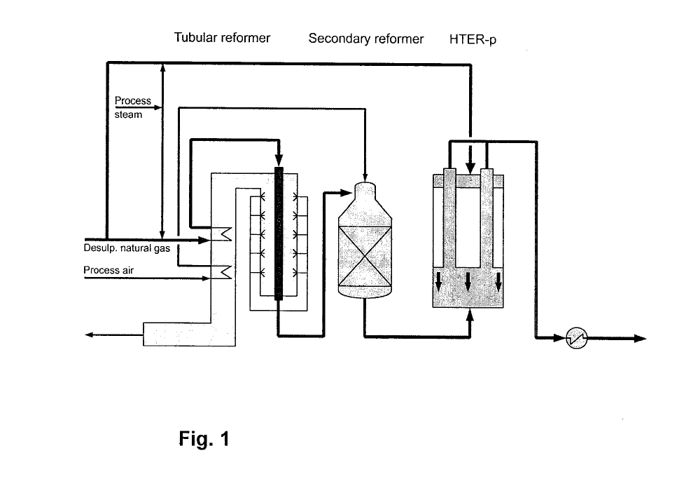

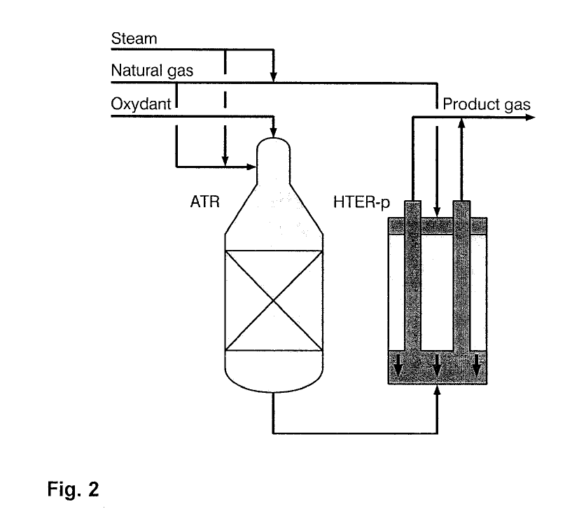

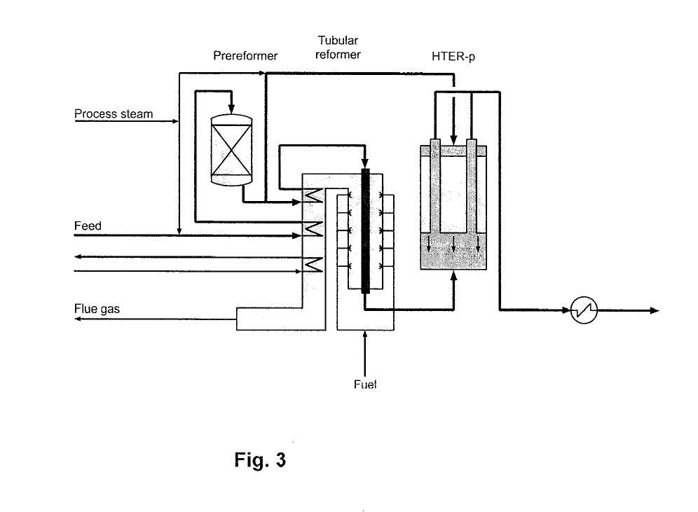

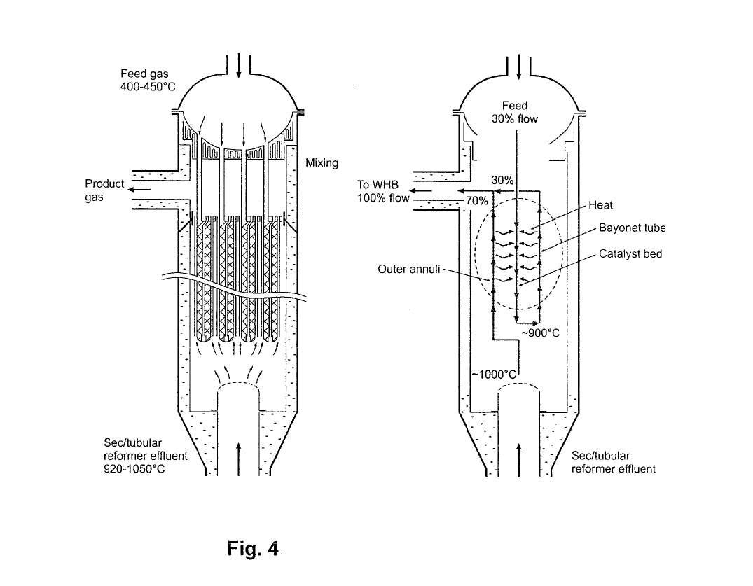

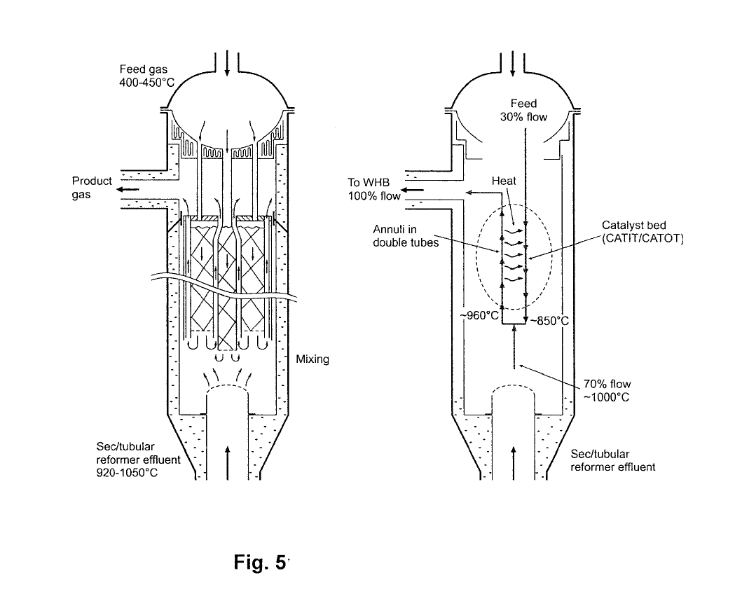

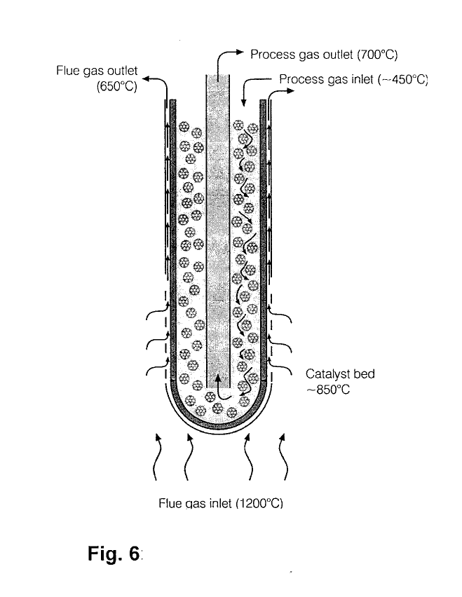

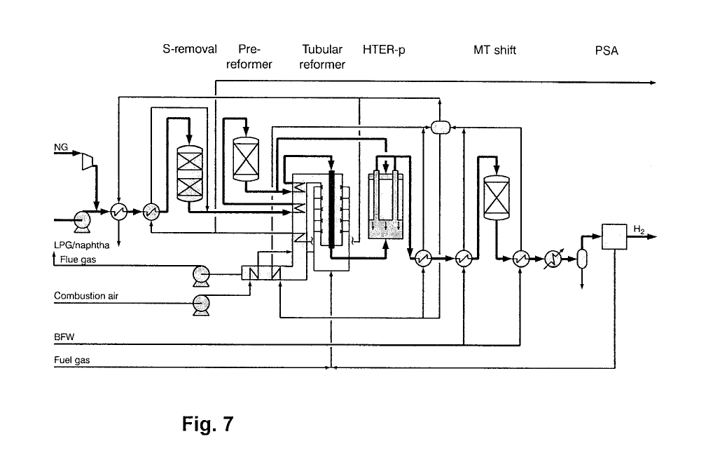

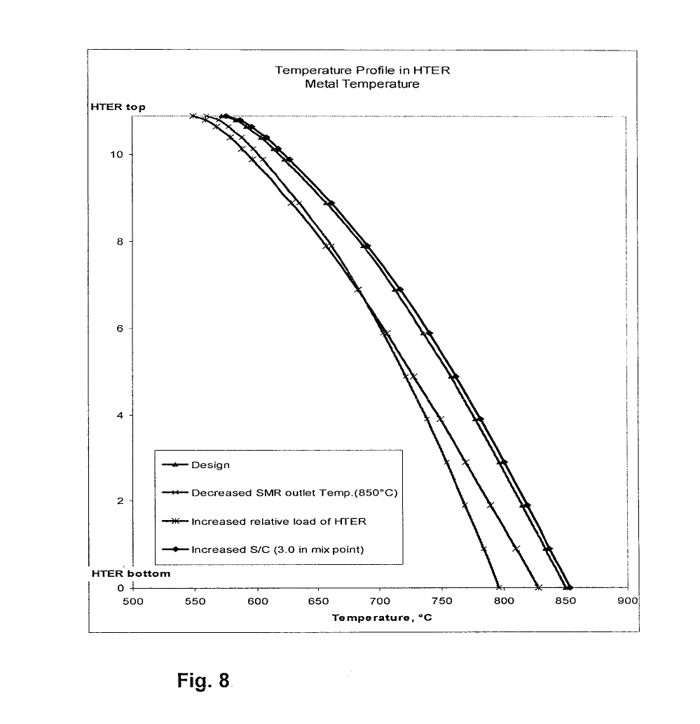

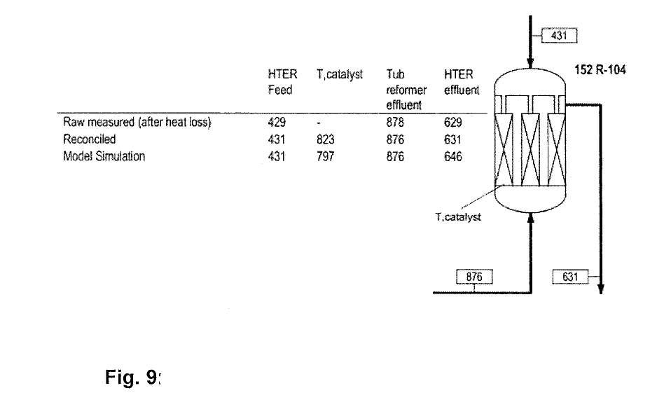

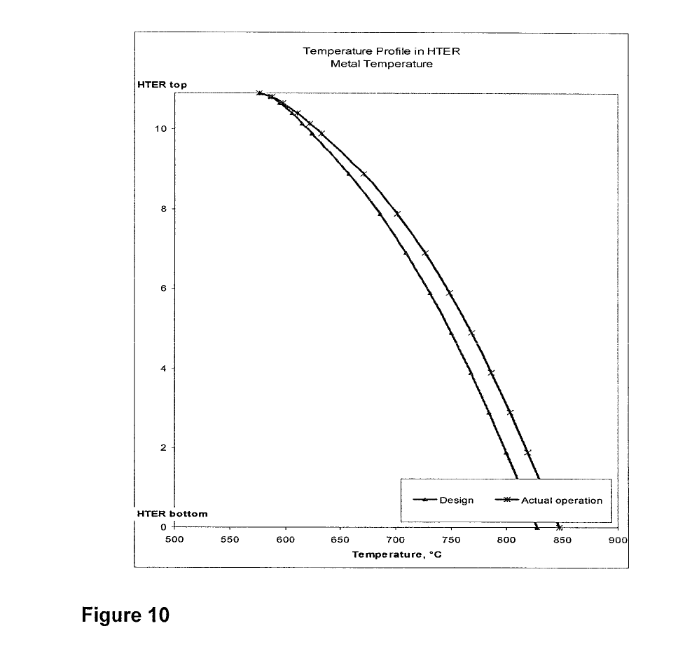

The term “inlet of the HER” is the inlet of effluent from the MRU to the HER. In the embodiment shown in FIG. 1, the inlet of the HER is the inlet from the main reforming unit, viz. the tubular reformer via the secondary reformer. The “inlet of the HER” is thus the lower inlet as shown in the bottom of the HTER-p in the embodiment of FIG. 1. One advantage of the invention is to obtain a heat exchange reformer and a method of ratio control for use in the operation of a heat exchange reformer, where the heat exchange reformer comprises at least two different metals. The metal having a lower resistance to metal dusting can be a cheaper metal which also has a higher mechanical strength, whilst the metal having a higher resistance to metal dusting is more expensive and has a lower relative mechanical strength. Since only a part of the reformer is made of the metal having a higher resistance to metal dusting, an overall cheaper and stronger reformer is possible. The method of the invention renders it possible to ensure that the reformer of the invention is operated in a way that the temperatures experienced in the different parts of the reformer are within the material specifications.

What is claimed is:

1. A Heat Exchange Reformer (HER) arranged to be part of a synthesis gas production unit, said synthesis gas production unit comprising a Main Reforming Unit (MRU) and said Heat Exchange Reformer (HER), wherein in operation the effluent from the MRU is arranged so as to provide heat to the HER, and wherein a hydrocarbon feedstock is arranged so as to pass in parallel through both the MRU and the HER, thus providing:
a. an MRU hydrocarbon feed having an MRU steam-to-carbon ratio (MRU_{S/C}), an effluent outlet temperature (T_{MRU}) and a MRU hydrocarbon flow rate (F_{MRU}) and
b. an HER hydrocarbon feed having an HER steam-to-carbon ratio (HER_{S/C}) and an HER hydrocarbon flow rate (F_{HER}),
wherein said Heat Exchange Reformer comprises a first metal and a second metal, in that:
at a distance greater than a distance (A) from the inlet of the HER, the HER is of a first metal having a higher resistance to metal dusting; and
at a distance less than said distance (A) from the inlet of the HER, the HER is of a second metal which has a lower resistance to metal dusting than said first metal,
wherein said distance A is determined from said temperature profile within the HER varying with the distance from the inlet of the HER as a function of the ratio of F_{HER}/F_{MRU}, the MRU outlet temperature (T_{MRU}), the MRU steam-to-carbon ratio (MRU_{S/C}), the HER steam-to-carbon ratio (HER_{S/C}) and the total hydrocarbon flow rate (F_{MRU}+F_{HER}); and wherein the distance (A) is as a distance (A) at which metal dusting is not significant.

2. An HER according to claim 1, wherein the distance (A) is a critical distance from the inlet to the simulated position of the lower temperature in a range of critical temperatures wherein an affinity for carbon formation for predetermined operation conditions.

3. An HER according to claim 1, wherein said distance (A) is said critical distance minus a safety margin distance.

4. An HER according to claim 1, wherein said predetermined operation conditions are specific operation conditions providing an optimum temperature profile within the HER, said specific operation conditions comprising one or more of the following: a specific feed flow rate to the HER; a specific feed flow rate to the MRU; a specific outlet temperature from the MRU (T_{MRU}); a specific steam-to-carbon-ratio (HER_{S/C}) provided to the HER; a specific MRU steam-to-carbon ratio (MRU_{S/C}); and a specific total hydrocarbon flow (F_{MRU}+F_{HER}).

5. An HER according to claim 1, wherein said inlet is the inlet of effluent from the MRU to the HER.

6. An HER according to claim 1, wherein the HER is a bayonet-type HER or a double-tube type HER.

7. An HER according to claim 1, wherein the MRU provides synthesis gas to a hydrogen plant, ammonia plant, methanol plant and/or synfuel plant.

8. An HER according to claim 1, wherein the MRU is selected from a tubular reformer (TR), an air-blown secondary reformer, an oxygen-blown secondary reformer and an autothermal reformer.

9. An HER according to claim 1, wherein the hydrocarbon feedstock comprises natural gas, LPG, naphtha, reformulated gasoline (RFG) or a mixture of LPG and naphtha.

10. A HER according to claim 1, wherein said synthesis gas production unit further includes a pre-reformer arranged upstream the MRU and/or the HER.

11. A method for improved thermal control in a Heat Exchange Reformer (HER) of a synthesis gas production unit, said synthesis gas production unit comprising a Main Reforming Unit (MRU) and a Heat Exchange Reformer (HER), wherein the effluent from the MRU is arranged so as to provide heat to the HER, and wherein a hydrocarbon feedstock is arranged so as to pass in parallel through both the MRU and the HER, thus providing:
a. an MRU hydrocarbon feed having a MRU steam-to-carbon ratio (MRU_{S/C}), an effluent outlet temperature (T_{MRU}) and a MRU hydrocarbon flow rate (F_{MRU}) and
b. an HER hydrocarbon feed having an HER hydrocarbon flow rate (F_{HER}),
said method comprising: adjusting the ratio of F_{HER}/F_{MRU} by adjusting the hydrocarbon flows to the MRU and HER on the basis of the MRU_{S/C}, the T_{MRU}, the HER_{S/C}, and the total hydrocarbon flow (F_{MRU}+F_{HER}), so as to maintain a stable temperature profile in the Heat Exchange Reformer (HER).

12. The method according to claim 11, wherein the method comprises increasing the ratio of F_{HER}/F_{MRU}.

13. The method according to claim 11, wherein the method comprises decreasing the ratio of F_{HER}/F_{MRU}.

14. The method according to claim 11, wherein the method comprises increasing or decreasing the MRU steam-to-carbon ratio (MRU_{S/C}), increasing or decreasing the MRU effluent outlet temperature (T_{MRU}), increasing or decreasing the HER steam-to-carbon ratio (HER_{S/C}) and/or increasing or decreasing the total hydrocarbon flow (F_{MRU} F_{HER}).

15. The method according to claim 11, wherein the method comprises increasing the TR steam-to-carbon ratio (TR_{S/C}).

16. A method according to claim 11, wherein the MRU provides synthesis gas to a hydrogen plant, ammonia plant, methanol plant and/or synfuel plant.

17. A method according to claim 11, wherein the MRU is selected from a tubular reformer (TR), an air-blown secondary reformer, an oxygen-blown secondary reformer and an autothermal reformer.

18. A method according to claim 11, wherein the effluent from the MRU is arranged to flow co-current or counter-current with the HER hydrocarbon feed in the HER.

19. A method according to claim 11, wherein the hydrocarbon feedstock comprises natural gas, LPG, naphtha, reformulated gasoline (RFG) or a mixture of LPG and naphtha.

20. Use of a method according to claim 11, for reduced metal dusting in the HER.

21. A computer readable storage medium comprising computer program code for execution by a processor, the computer program code comprising instructions for carrying out the method of claim 11.
